(19) United States
(12) Patent Application Publication
(10) Pub. No.: US 2005/0010563 A1
(43) Pub. Date: Jan. 13, 2005

(54) Internet search application

(76) Inventors: William Gross, Pasadena, CA (US); Charlie McElfresh, La Canada, CA (US); Steven Lee Colwell, Santa Barbara, CA (US); Mark Goodstein, Pasadena, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/844,980

(22) Filed: May 13, 2004

Related U.S. Application Data
(60) Provisional application No. 60/470,821, filed on May 15, 2003.

(51) Int. Cl. G06F 7/00

(52) U.S. Cl. 707/3

(57) ABSTRACT

A search system comprises code. The code, when executed, is configured to generate a search mode interface including a search field, a list area for displaying a list of search result items, and a view area for displaying at least a portion of the contents of a selected search item. The code, when executed, is further configured to transmit a search query entered into the search field to an Internet search application. The code, when executed, is further configured to display search results received from the Internet search application. The code, when executed, is further configured to automatically retrieve webpages corresponding to at least a portion of the search results. The code, when executed, is further configured to display at least a portion of a first retrieved webpage in the view area at least partly in response to a selection of an item in the search results. The code, when executed, is further configured to detect a change of user focus from the list area to the view area. The search system further comprises an accounting module configured to record the change of focus from the list area to the view area. The accounting module is further configured to apply a charge to an account associated with the webpage displayed in the view area at lest partly in response to the change of focus.

### PRIORITY APPLICATION

This application claims the benefit of U.S. Provisional Patent Application 60/470,821, filed 15 May 2003, the entire contents of which are hereby incorporated by reference herein.

### FIELD OF THE INVENTION

The present invention relates generally to an Internet searching application, and more specifically to an Internet searching application capable of tracking how a user browses results from a web search.

### BACKGROUND OF THE INVENTION

Advertisers often pay Internet search engine administrators fees in exchange for a listing or for a more prominent listing when the search engine provides a user with a list of search results. A wide variety of payment options exist, and include pay-per-click (“PPC”) arrangements wherein a PPC advertiser pays a fixed fee each time a user follows a link from the search engine results to the advertiser's website. For example, in one variant of a PPC arrangement, advertisers submit bids for the amount they are willing to pay, on a “per-click” basis, to be at or near the top of the search results displayed to a user.

In the PPC arrangements described above, the fee an advertiser pays to a search engine is proportional to the amount of web traffic generated from that search engine. Thus, a search engine that refers a high volume of users to an advertiser's website will generate more revenue than a search engine that refers a low volume of users. For advertisers, such an arrangement is more attractive than a flat monthly fee, for example, because when an advertiser pays a flat fee, the amount paid to the search engine may not be proportional to the volume of traffic generated by that search engine. This arrangement also provides advertisers with a straightforward way to identify their most valuable referral sources.

PPC arrangements generally need to include the ability to track how users are referred to an advertiser's website. Tracking allows a search engine to monitor the volume of traffic it provides to a particular advertiser, thus allowing the advertising fees to be calculated appropriately. One technique for tracking involves the use of a coded uniform resource locator (“URL”) that contains embedded information on the referring search engine. The advertiser, the search engine or both can use the coded URL to track referral sources. Advantageously, coded URLs can be used in a way that is substantially transparent to the user, and does not require user intervention.

### SUMMARY OF THE INVENTION

In accordance with the foregoing, an improved Internet search application has been developed. The improved system combines features that make it easier for users to browse listings of search results with features that allow advertisers to increase the quality of the Internet traffic for which they pay.

In one embodiment of the present invention, a search system comprises code. The code, when executed, is configured to generate a search mode interface including a search field, a list area for displaying a list of search result items, and a view area for displaying at least a portion of the contents of a selected search item. The code, when executed, is further configured to transmit a search query entered into the search field to an Internet search application. The code, when executed, is further configured to display search results received from the Internet search application. The code, when executed, is further configured to automatically retrieve webpages corresponding to at least a portion of the search results. The code, when executed, is further configured to display at least a portion of a first retrieved webpage in the view area at least partly in response to a selection of an item in the search results. The code, when executed, is further configured to detect a change of user focus from the list area to the view area. The search system further comprises an accounting module configured to record the change of focus from the list area to the view area. The accounting module is further configured to apply a charge to an account associated with the webpage displayed in the view area at lest partly in response to the change of focus.

In another embodiment of the present invention, an apparatus comprises a first instruction configured to generate a search interface including a search field, a list area, and a view area. The apparatus further comprises a second instruction configured to search a computer network based on a search query entered into the search field. The apparatus further comprises a third instruction configured to display a listing of search results generated by the second instruction in the list area. The third instruction is also configured to display at least a portion of a selected page corresponding to one of the search results in the view area. The apparatus further comprises a fourth instruction configured to detect a change of user focus from the list area to the view area. The apparatus further comprises a fifth instruction configured to apply a charge to an account associated with the selected page displayed in the view area at least partly as a result of the change of focus.

In another embodiment of the present invention, a method of providing search results comprises transmitting program code and formatting code to a client. The program code and formatting code are configured to generate a search interface including a search field, a list area for displaying search result items, and a view area for displaying at least a portion of a selected search item. The program code and formatting code are further configured to transmit a search query entered into the search field over a network to a remote search system. The program code and formatting code are further configured to display a listing of results received from the remote search system in the list area. The program code and formatting code are further configured to display at least a portion of a page corresponding to at least one of the results listed in the list area. The displayed page is retrieved from a first network location and displayed in the view area. The program code and formatting code are further configured to detect a change in focus from the list area to the view area. Upon detection of the change in focus, the program code and formatting code are configured to transmit a second network location that causes an account associated with the webpage to be charged.

In another embodiment of the present invention, a method comprises displaying a listing of search results in a list area of a user interface. The method further comprises displaying at least a portion of a selected search result in a view area of the user interface. The method further comprises detecting a change in focus from the list area to the view area. Upon detecting the change in focus, the method further comprises accessing a coded network address configured to cause an account associated with the selected search result to be charged.

In another embodiment of the present invention, an apparatus comprises a first computer. The first computer is configured to generate a search mode interface including a list area for displaying a list of search result items and a view area for displaying at least a portion of the contents of a selected search item. The first computer is further configured to detect a change in user focus to the view area. The apparatus further comprises a second computer that is configured to receive a search request from the first computer, to generate search results based on the search request, and to transmit the search results to the first computer. The apparatus further comprises an accounting module configured to charge an account associated with a search results displayed in the view area when the change in user focus is detected.

In another embodiment of the present invention, a system comprises search code that generates search results based on a search of a computer network for information related to a search query. The system further comprises display code. The display code generates a search interface including a list area for displaying a listing of the search results. The display code also generates a view area for displaying at least a portion of a webpage corresponding to a selected search result. The system further comprises accounting code that detects a change in focus to the view area and charges an account associated with the webpage displayed in the view area when said change in focus is detected.

### BRIEF DESCRIPTION OF THE DRAWINGS

FIG. 1 is a screen shot of an exemplary embodiment of an Internet search application having an index pane and a content pane.

FIG. 2 is a screen shot of the Internet search application of FIG. 1 wherein the user has focused on the content pane.

FIG. 3 is a flowchart illustrating the operation of the Internet search application of FIG. 1.

FIG. 4 is a schematic diagram illustrating the Internet search application of FIG. 1.

### DETAILED DESCRIPTION OF PREFERRED EMBODIMENTS

Throughout the following description, the term “website” is used to refer to a user-accessible server site that implements the basic World Wide Web standards for the coding and transmission of hypertextual documents. These standards currently include HTML (the Hypertext Markup Language) and HTTP (the Hypertext Transfer Protocol). It should be understood that the term “site” is not intended to imply a single geographic location, as a web or other network site can, for example, include multiple geographically distributed computer systems that are appropriately linked together. Furthermore, while the following description relates to an embodiment utilizing the Internet and related protocols, other networks, such as networked interactive televisions, and other protocols may be used as well.

Additionally, unless otherwise indicated, the functions described herein are preferably performed by software modules including executable code and instructions running on one or more general-purpose computers. The computers can include one or more central processing units (CPUs), that execute program code and process data, memory, including one or more of volatile memory, such as random access memory (RAM) for temporarily storing data and data structures during program execution, non-volatile memory, such as a hard disc drive, optical drive, or FLASH drive, for storing programs, data, and databases, and one or more network interfaces for accessing an intranet and/or Internet.

Additionally, the computers can include a display for displaying user interfaces, data, photographs, images, and the like. The computers can also include one or more user input devices, such as a keyboard, mouse, pointing device, microphone and/or the like, used to navigate, provide commands, enter information, and/or the like. However, the present invention can also be implemented using special purpose computers, state machines, and/or hardwired electronic circuits. In addition, the example processes described herein do not necessarily have to be performed in the described sequence, and not all states have to be reached or performed.

Further, while the following description may refer to “clicking on” a link or button, or pressing a key in order to provide a command or make a selection, the commands or selections can also be made using other input techniques, such as using voice input, pen input, mousing or hovering over an input area, selecting menu options, and/or the like.

In some conventional web interfaces, a user views search results produced by a search engine in a browser window. When the user identifies a link that merits further exploration, the user clicks on that link, thereby causing the user's browser to be redirected to the website of interest. As described above, in certain embodiments a coded URL can be used to provide the search engine with information regarding which advertiser should incur a referral fee, and with information regarding which page to display. Once the user's browser is pointed at the target website, the user can further explore from that target website.

One disadvantage to this conventional configuration is that, in certain cases, the user can experience some difficulty in returning to the search results after exploring a website identified in a search result. Another disadvantage is that the user is unable to preview the websites listed in the search engine results before actually visiting those websites, resulting in the user being referred to some websites that are not of interest to the user. This not only is inconvenient for the user, but PPC advertisers seek to avoid paying for referrals of users who are not actually interested in the PPC advertiser's content.

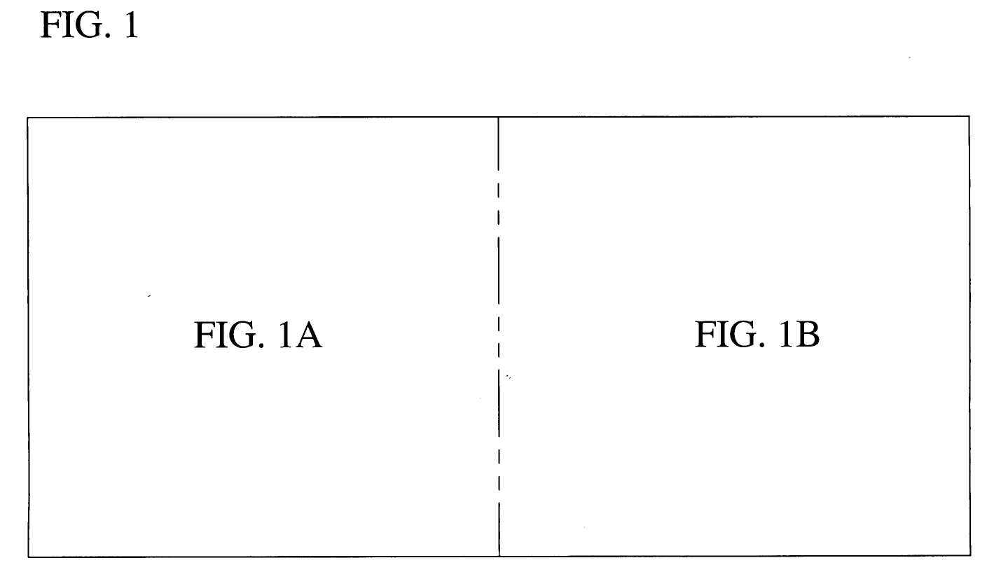

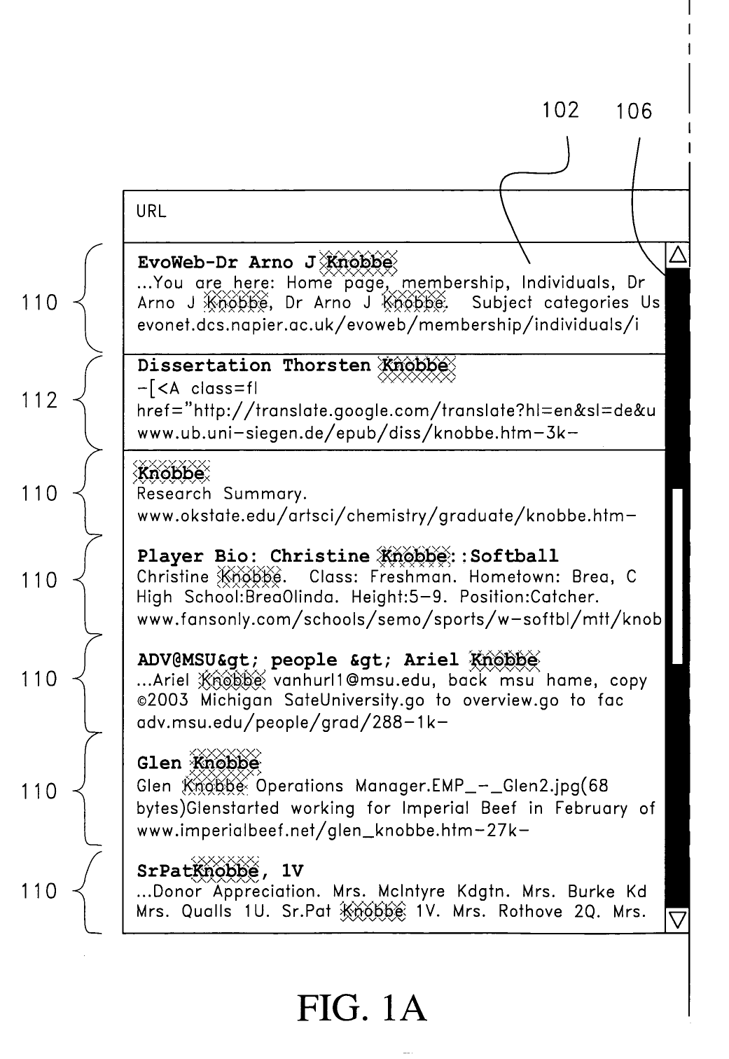

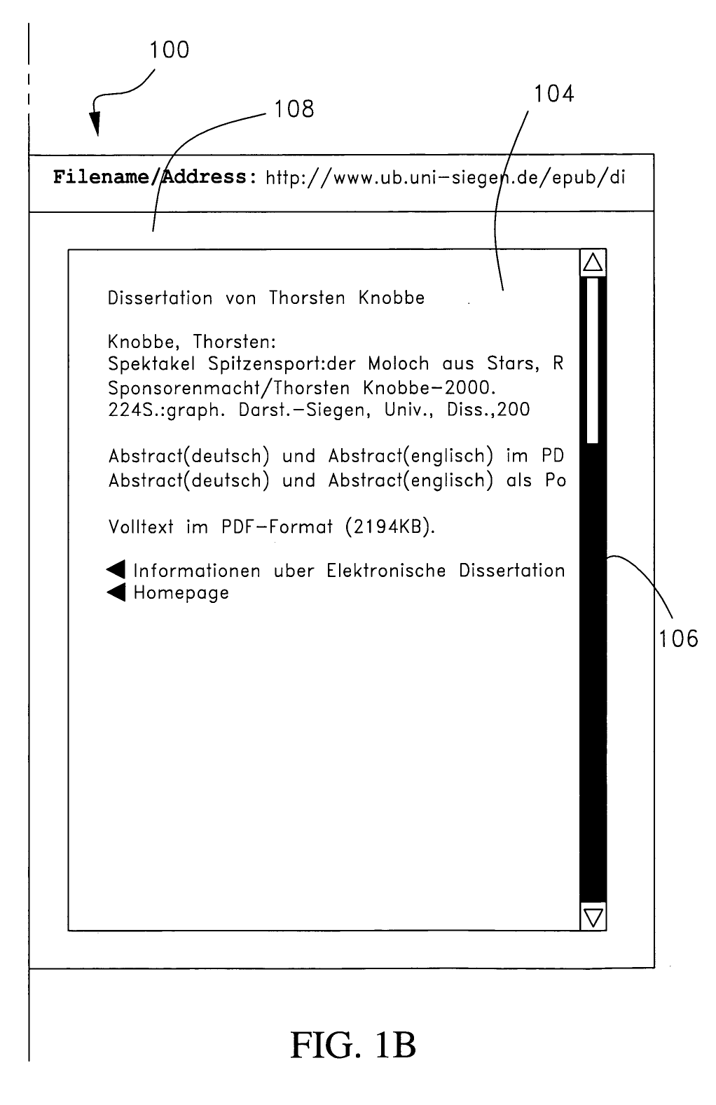

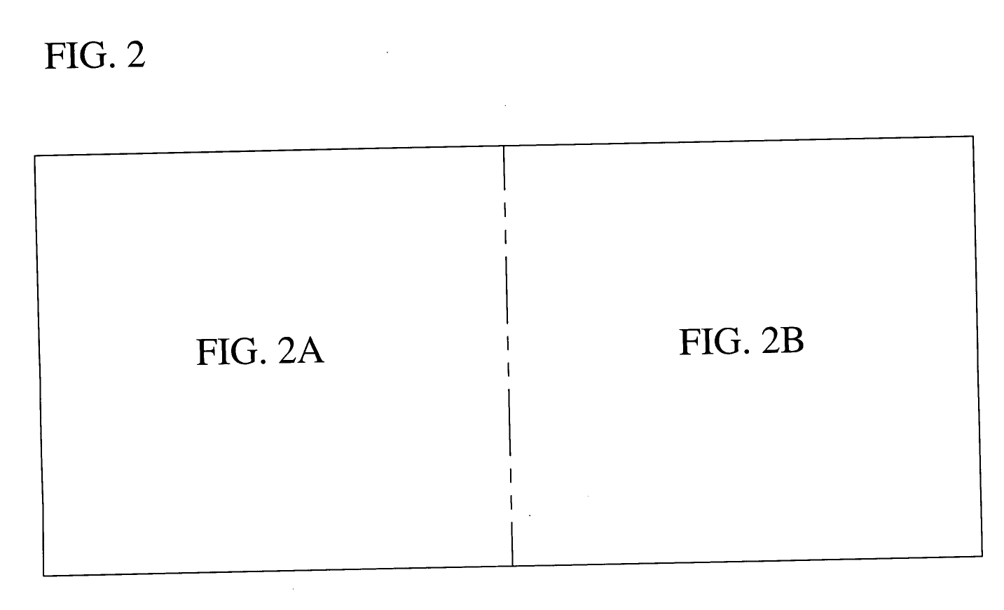

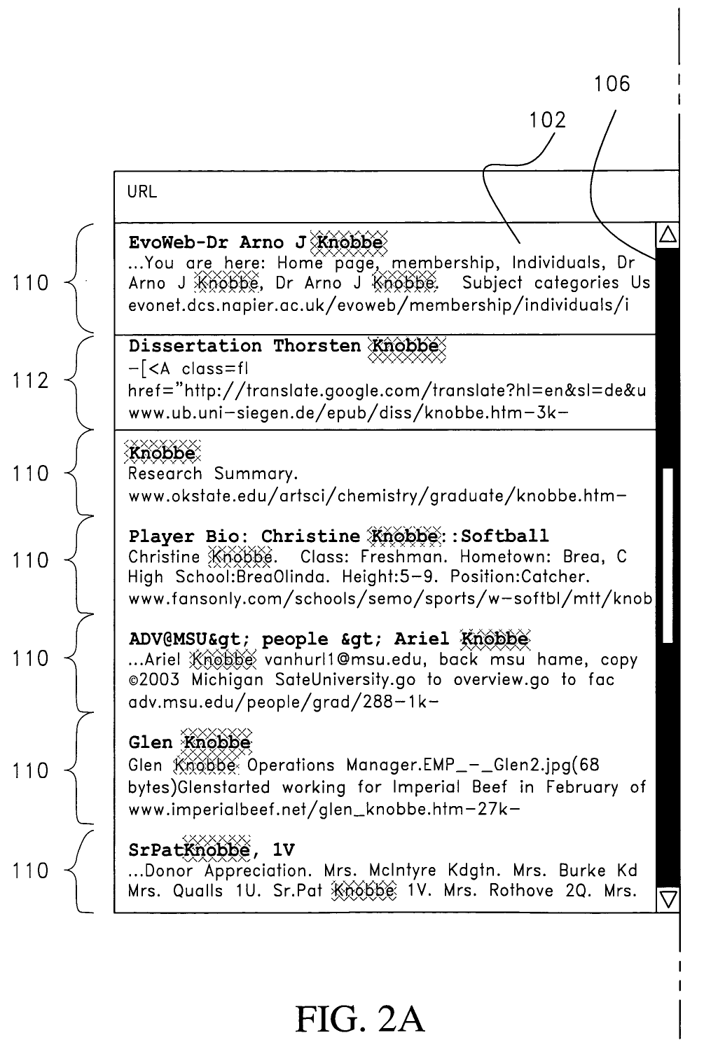

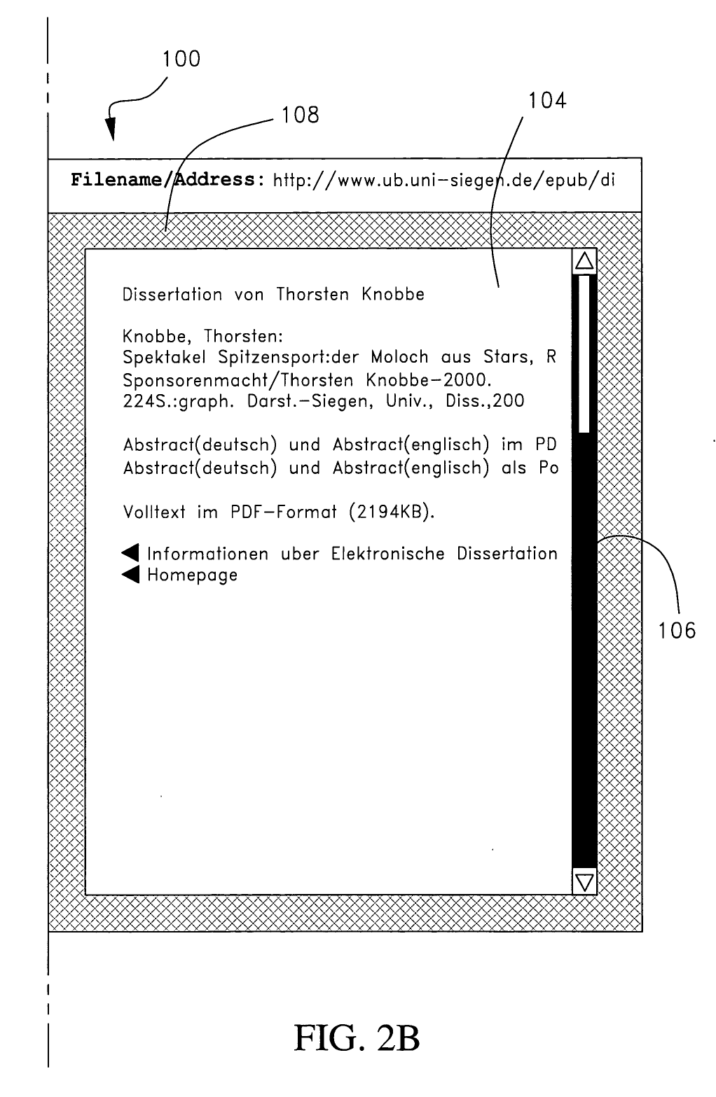

These difficulties are addressed in an exemplary embodiment of the Internet search application described herein and illustrated in FIGS. 1 and 2. By way of example, the application can be implemented using instructions, modules, and/or the like that are executed on by one or more computer systems. As illustrated in FIGS. 1 and 2, the Internet search application comprises an example user interface 100. The user interface 100 includes two display areas, which can be in the form of an index pane 102 and a content pane 104. The index pane and the content pane 104 optionally include scrollbars 106. In other embodiments, the content pane 104 can comprise a second window that is separate from the index pane 102, thereby providing the user with more flexibility to independently move, orient and size the two panes.

When a user submits a search using the user interface 100, a listing or a partial listing of the search results 110 appears in the index pane 102. Initially, the first listed search result in the index pane 102 has its content displayed in the content pane 104. When the user selects one of the search results 110 in the index pane 102, the content of the selected search result 112 appears in the content pane 104. The user can select a particular search result 110 by any number of techniques, including for example, clicking on the search result or pointing at it using a mouse, trackball or other pointing device. The user can then explore the content of the selected search result in the content pane 104 while still being able to easily return to the search results which remain displayed in the index pane 102. In a modified embodiment, the user interface 100 can be configured to display additional information about the search results 110 in the index pane 102, such as a network address corresponding to a location on a computer network where files corresponding to a particular search result are stored.

Such a user interface can be used in conjunction with a modified PPC advertising system. The operation of an exemplary modified PPC advertising system is illustrated in the flowchart of FIG. 3. In such a system, a user submits a search inquiry via the user interface 100 in an operational block 310. In operational block 320, a search is performed based on the user's inquiry, and the user interface 100 displays the results of the search in index pane 102. In one embodiment, the search is performed by the same software that provides the user interface 100; in a modified embodiment, the search is performed by a distinct searching component, such as an independent Internet search engine. The search can be executed on the same computer used to generate the user interface, or can be executed on a remote computer, such as a computer dedicated to performing Internet searches. In still other embodiments, a plurality of searches can be performed by a variety of different Internet search engines, with the user interface 100 compiling a composite set or further filtered set of search results.

In embodiments wherein the search is performed by a distinct searching component, the user interface can be configured to resolve a coded URL returned from the distinct searching component into a non-coded URL. Such a feature can be advantageous when the distinct searching component has a different set of PPC advertisers than the user interface. In particular, this feature allows the user interface or related application to sort search results retrieved from a distinct searching component based on the set of PPC advertisers associated with the user interface or user interface provider. In one embodiment, the act of resolving a coded URL returned from the distinct searching component involves a publicly available algorithm, such as a text string manipulation algorithm. In another embodiment, the resolving act involves use of a proprietary algorithm developed by the distinct searching component administrator. For example, the coded URL can be sent to a server capable of resolving the coded URL. In still another embodiment, both a coded URL and a standard URL are retrieved from the distinct searching component; in such embodiments, the standard URL is used to display a website in the content pane 104, and the coded URL is used when the user focuses on the content pane 104. Thus, for example, the coded URL is used when the advertiser is to incur a charge or pay a fee for a given search result/impression, and the standard URL is used when the advertiser is not to incur a charge or pay a fee for a given search result/impression.

In an exemplary embodiment, when the user interface 100 displays the search results in the index pane in operational block 320, at least a portion of the search results can comprise links to websites associated with PPC advertisers. For example, in one embodiment the user interface sorts the search results based at least partially on PPC advertiser status, with websites associated with PPC advertisers appearing more prominently than websites not associated with PPC advertisers. In such embodiments, the status of a website as associated or not associated with a PPC advertiser can be latent to the user or can be explicitly disclosed to the user via text, positioning, and/or other perceptual indication.

Once the search results are displayed in the index pane 102, the user can then browse through the search results by, for example, scrolling through the search results. In a modified embodiment, the user can browse through the search results by instructing the user interface 100 to present a “slideshow” wherein each search result is briefly displayed to the user. In such embodiments; the user can move from viewing one search result to the next manually (such as by clicking a mouse or pressing a button on a keyboard), or each search result can be displayed for a specified time period before the next result is automatically displayed. When the user identifies a search result of particular interest, the user can indicate such interest by selecting the search result, as illustrated in FIG. 3 in operational block 330. The selection can be performed by clicking on or hovering over the desired search result 110 using a mouse, trackball, keyboard, or other user interface. The user interface 100 then displays the selected search result 112 in the content pane 104 in an operational block 340.

This configuration allows the user to review the web page corresponding to an individual search result of interest by selecting that search result from the index pane 102. In one embodiment, if the user changes the focus to the content pane 104, this action will cause the PPC advertiser associated with that search result, if any, to incur a referral fee. This operation is represented by decision block 350 and operational block 360 in FIG. 3. As used herein, “changing the focus” refers, in addition to its ordinary meaning, to a user action that causes the content pane 104 to become active. Examples of “changing the focus” user actions include, but are not limited to, clicking on the content pane 104, selecting the content pane 104, printing the content pane 104, using a content pane scrollbar 106, tabbing to the content pane 104, or copying contents of the content pane 104 to memory. The activation or selection can be performed by the user by clicking on, keying to, or otherwise selecting the content pane, via a mouse, trackball, keyboard, electronic pen, voice command, or other user interface. In one embodiment, the underlying operating system detects a changing of the focus. If the user elects not to change the focus to the content pane 104, the user interface 100 can be configured to wait for further user input, such as by selecting a different search result for preview in the content pane 104, or by performing a different search.

In embodiments wherein an independent search engine is used to perform the search and retrieve the search results, the user interface can be configured to provide the independent search engine with information regarding whether a particular advertiser should be charged a referral fee. For example, if the user interface instructs the independent search engine to retrieve a PPC advertiser's webpage for initial display in the content pane 104, then the user interface can instruct the independent search engine to not charge the PPC advertiser a referral fee. This can be accomplished, for example, by configuring the user interface to resolve the PPC advertiser's coded URL into a standard URL, and displaying the website associated with the standard URL in the content pane 104.

However, once the user focuses on the retrieved webpage or browses links within the retrieved webpage, the user interface can instruct the independent search engine to charge the PPC advertiser a referral fee. In one embodiment, the user interface accomplishes this by accessing the PPC advertiser's coded URL as retrieved from the independent search engine, thereby displaying the coded URL webpage in the content pane 104 and causing the PPC advertiser to incur a referral fee. In a modified embodiment, the user interface accomplishes this by displaying the standard URL webpage in the content pane 104 while accessing the coded URL in the background without displaying the corresponding coded URL webpage. Generally, in the foregoing embodiments, the instructions from the user interface to the independent search engine can be provided using a variety of techniques, including through the use of coded URLs, as described above.

In the exemplary embodiments of the user interface 100 illustrated in FIGS. 1 and 2, the content pane 104 further comprises a dynamic border 108. In such embodiments, the color or some other visible property of the dynamic border 108 changes when the user focuses on the content pane 104, thereby providing an indication that the user has changed focus to the content pane 104, which, when applicable, causes a PPC advertiser to incur a referral fee. However, the dynamic border is optional: the user interface 100 has significant utility as described herein even if the user is not alerted to when a PPC advertiser incurs a referral fee. Other types of indicators, such as highlighting, change in background color, audible alert, and/or the like can also be used to provide an indication as to which pane is active or being focused on.

In the configuration described above, the PPC advertiser, if any, does not incur a charge until the user changes the focus to the content pane 104. This advantageously reduces the likelihood that the PPC advertiser will be charged for “low quality” traffic. As used herein, “low quality” traffic refers, in addition to its ordinary meaning, to website traffic from users who have a reduced interest in the website being viewed. For example, if a user follows a link returned by a conventional search engine, there is some chance that the user will be directed to a page containing information that is not useful to the user. In contrast, by using the Internet search tool described herein, the user can “preview” the search result in the content pane 104 without causing the PPC advertiser to incur a charge. Thus, if the user does eventually change the focus to the content pane 104, such as by scrolling through the search result content using scrollbars 106, there is a higher likelihood that the user will have an increased interest in the website being viewed. This reduces the extent to which the PPC advertiser pays for “low quality” traffic, thereby providing a more valuable service to PPC advertisers.

The extent to which a PPC advertiser pays for “low quality” traffic can be further reduced by making the magnitude of the referral charge dependent on any number of a variety of criteria. For example, the referral change can be increased if the user views a particular search result for an extended time, scrolls extensively through the search result or follows further links within the particular search result. Likewise, the referral charge can be decreased if the user views a particular search result for a limited time, does not scroll through the search result, or does not follow further links within the particular search result.

In a modified embodiment wherein a conventional web browser is used to perform Internet searching, the extent to which a PPC advertiser pays for “low quality” traffic can be further reduced by monitoring a user's actions after an advertiser's website is viewed. In such embodiments, a user reviews an indexed listing of search results and can follow a link to review a particular advertiser's website in greater detail. If, shortly after following the link, the user uses the browser's “back” button to return to the search result index, the advertiser will not be charged a referral fee. Such a “free visit” is provided because the short visit suggests that the user was not highly interested in the advertiser's content, and that the user's visit was “low quality” traffic. In contrast, if the user views the advertiser's website for longer than a threshold time duration, then the advertiser will be charged a referral fee because the user appeared to have greater interest in the advertiser's content. The threshold time for triggering a referral fee charge can be an appropriate time duration. This configuration can be used to further reduce the extent to which a PPC advertiser pays for “low quality” traffic.

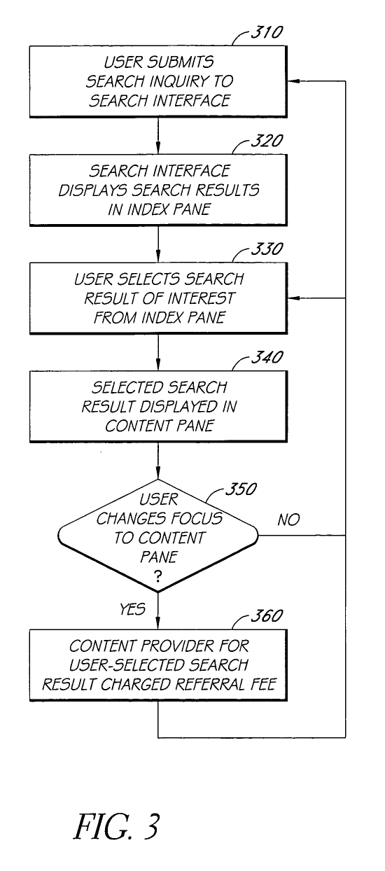

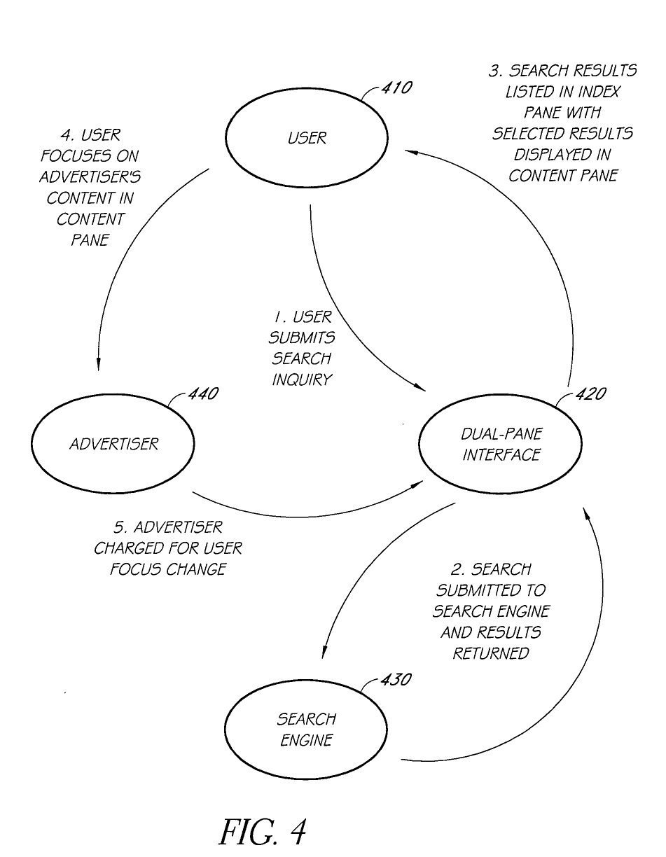

FIG. 4 is a schematic diagram of an exemplary embodiment of the modified PPC advertising system described herein. As illustrated in FIG. 4, a user 410 submits a search inquiry to a dual-pane search interface 420 in a first operational step. In a second operational step, the dual-pane search interface 420 submits the search to a search engine 430, which returns the search results to the dual-pane search interface 420. As described above, the search engine 430 can be integral with or distinct from the dual-pane search interface 420.

Still referring to FIG. 4, in a third operational step the dual-pane search interface 420 lists the search results in the user interface index pane 102 (see FIGS. 1 and 2). In one embodiment, search results corresponding to PPC advertisers are listed more prominently in the index pane 102. The user 410 can then select search results of interest for preview in the content pane 104. When the user 410 identifies a search result of particular interest, he or she can then focus on the content pane 104 in a fourth operational step. By changing the focus to the content pane 104, the advertiser 440 incurs a referral fee in a fifth operational step.

### SCOPE OF THE INVENTION

While the foregoing detailed description has described several embodiments of the present invention, it should be understood that the above description is illustrative only and is not limiting of the disclosed invention. It will be appreciated that the specific configurations and operations disclosed can differ from those described above, and that the methods described herein can be used in contexts other than Internet searching, including for example in the context of file system searching.

1. A search system comprising:
code, which when executed is configured to:
(a) generate a search mode interface including a search field, a list area for displaying a list of search result items, and a view area for displaying at least a portion of the contents of a selected search item;
(b) transmit a search query entered into the search field to an Internet search application;
(c) display search results received from the Internet search application;
(d) automatically retrieve webpages corresponding to at least a portion of the search results;
(e) display at least a portion of a first retrieved webpage in the view area at least partly in response to a selection of an item in the search results; and
(f) detect a change of user focus from the list area to the view area; and
an accounting module configured to record the change of focus from the list area to the view area, and to apply a charge to an account associated with the webpage displayed in the view area at lest partly in response to the change of focus.

2. The search system of claim 1, wherein the code is further configured to highlight the view area when a change of user focus is detected.

3. The search system of claim 1, wherein the code is script code.

4. The search system of claim 1, wherein the webpages are retrieved using a non-coded uniform resource locator.

5. The search system of claim 1, wherein the code is further configured to display a network address corresponding to at least a portion of the search results.

6. The search system of claim 1, wherein the code is further configured to display the retrieved webpages in a slideshow.

7. The search system of claim 1, wherein the change of focus results from a user selecting the view area using a computer input device.

8. The search system of claim 1, wherein the accounting module is further configured to periodically compile a list of charges associated with a webpage.

9. An apparatus comprising:
a first instruction configured to generate a search interface including a search field, a list area, and a view area;
a second instruction configured to search a computer network based on a search query entered into the search field;
a third instruction configured to display a listing of search results generated by the second instruction in the list area, and to display at least a portion of a selected page corresponding to one of the search results in the view area;
a fourth instruction configured to detect a change of user focus from the list area to the view area; and
a fifth instruction configured to apply a charge to an account associated with the selected page displayed in the view area at least partly as a result of the change of focus.

10. The apparatus of claim 9, wherein the change of user focus is indicated by a user clicking on a viewed page.

11. The apparatus of claim 9, wherein the page is a webpage.

12. The apparatus of claim 9, further comprising a server that hosts the first, second, third, fourth and fifth instructions.

13. The apparatus of claim 9, wherein the search interface enables the user to adjust a view area size and a list area size.

14. The apparatus of claim 9, wherein the computer network is the Internet.

15. The apparatus of claim 9, wherein the second instruction is configured to search a plurality of computer networks.

16. The apparatus of claim 9, further comprising a sixth instruction configured to sort the search results in the list area according to a user-defined relevancy criterion.

17. The apparatus of claim 9, wherein scrolling to view an un-displayed portion of the selected webpage triggers a change of focus.

18. A method of providing search results comprising:
transmitting program code and formatting code to a client, the program code and formatting code configured to:
generate a search interface including a search field, a list area for displaying search result items, and a view area for displaying at least a portion of a selected search item;
transmit a search query entered into the search field over a network to a remote search system;
display a listing of results received from the remote search system in the list area;
display at least a portion of a page corresponding to at least one of the results listed in the list area, wherein the displayed page is retrieved from a first network location and displayed in the view area;
detect a change in focus from the list area to the view area, and upon detection of the change in focus, transmitting a second network location that causes an account associated with the webpage to be charged.

19. The method of claim 18, wherein the program code is script.

20. The method of claim 18, wherein the formatting code is HTML.

21. The method of claim 18, wherein the search query is transmitted to a plurality of Internet search systems.

22. The method of claim 18, further comprising filtering the results received from the remote search system before displaying the results in the list area, the filtering performed according to a user-defined criterion.

23. The method of claim 18, wherein the second network location is associated with a uniform resource locator configured to cause an account associated with a webpage to be charged when accessed.

24. The method of claim 18, wherein locator information associated with the first network location is displayed in the list area.

25. A method comprising:
displaying a listing of search results in a list area of a user interface;
displaying at least a portion of a selected search result in a view area of the user interface;
detecting a change in focus from the list area to the view area; and
upon detecting the change in focus, accessing a coded network address configured to cause an account associated with the selected search result to be charged.

26. The method of claim 25, wherein the network address is a coded uniform resource locator.

27. The method of claim 25, wherein the search results listed in the list area are indexed according to a relevancy score determined by user-defined parameters.

28. The method of claim 25, wherein the change in focus comprises user selection of the view area using an input device.

29. The method of claim 25, wherein the change in focus comprises scrolling to display a previously un-displayed portion of the selected search results in the view area.

30. The method of claim 25, further comprising:
sending a search query to an Internet search system;
receiving a search result from the Internet search system, wherein the search result includes a coded network locator that causes an account associated with a corresponding webpage to be charged when the coded network locator is accessed; and
resolving the coded network locator into a non-coded network locator; and
displaying a page received from the non-coded network locator in the listing of search results.

31. An apparatus comprising:
a first computer that is configured to (a) generate a search mode interface including a list area for displaying a list of search result items and a view area for displaying at least a portion of the contents of a selected search item, and (b) detect a change in user focus to the view area;
a second computer that is configured to receive a search request from the first computer, to generate search results based on the search request, and to transmit the search results to the first computer; and
an accounting module configured to charge an account associated with a search results displayed in the view area when the change in user focus is detected.

32. The apparatus of claim 31, wherein scrolling through the search result displayed in the view area triggers a change in user focus.

33. The apparatus of claim 31, wherein a change in user focus results from a user selecting the view area using a computer input device.

34. The apparatus of claim 31, wherein the accounting module is further configured to periodically compile a list of charges associated with a search result.

35. The apparatus of claim 31, wherein the search result is a webpage.

36. A system comprising:
search code that generates search results based on a search of a computer network for information related to a search query;
display code that generates a search interface including a list area for displaying a listing of the search results, and a view area for displaying at least a portion of a webpage corresponding to a selected search result; and
accounting code that detects a change in focus to the view area and charges an account associated with the webpage displayed in the view area when said change in focus is detected.

37. The system of claim 36, wherein scrolling through the webpage displayed in the view area triggers a change in focus.

38. The system of claim 36, wherein the search results generated by the search code are referenced by a coded uniform resource locator that, when accessed, is configured to cause an account associated with a corresponding webpage to be charged.

39. The system of claim 36, further comprising address resolution code that resolves a coded network address into a non-coded network address.

40. The system of claim 36, further comprising:
address resolution code that resolves a coded network address into a non-coded network address,
wherein the address resolution code is executed on a second computer, and the search code is executed on a first computer.
